(19) United States
(12) Patent Application Publication
(10) Pub. No.: US 2026/0154736 A1
(43) Pub. Date: Jun. 4, 2026

(54) AI-Assistant-Driven Testing Methods and System for Financial Crime Assessment and Monitoring Systems

(71) Applicants: Asem Othman, Gainesville, VA (US); Jose Caldera, San Francisco, CA (US); Bin Tang, Palo Alto, CA (US)

(72) Inventors: Asem Othman, Gainesville, VA (US); Jose Caldera, San Francisco, CA (US); Bin Tang, Palo Alto, CA (US)

(73) Assignee: Yanez Compliance, Inc, (omitted)

(21) Appl. No.: 18/967,460

(22) Filed: Dec. 3, 2024

(51) Int. Cl. G06Q 40/02

(52) U.S. Cl. CPC G06Q 40/024

(57) ABSTRACT

The systems and methods presented enable the testing of Financial Crime Assessment and Monitoring Systems (FCAMS). At its core, the YANEZ AI Sanction Assistant powers a synthetic input generator, which produces configurable synthetic inputs based on target financial crime scenarios. An assessment module then evaluates these synthetic inputs, integrating the inputs into FCAMS and collecting results from the system under review. A reporting module analyzes the received results, producing test scores, insights, suggested actions, and a range of metrics and analytics. A feedback module gathers user feedback and incorporates it to refine the results. An AI-driven engine continuously learns from input scenarios, configurations, results, and feedback to improve synthetic input generation and the overall assessment process.

The data ingestion module aggregates and processes up-to-date data from regulatory sources, commercial databases, and publicly available information, ensuring that the synthetic inputs remain comprehensive and reflect the latest financial crime trends.

YANEZ system for testing Financial Crime Assessment and Monitoring Systems (FCAMS) operates through a comprehensive, multi-agent architecture designed to rigorously evaluate and enhance the effectiveness of financial crime prevention mechanisms.

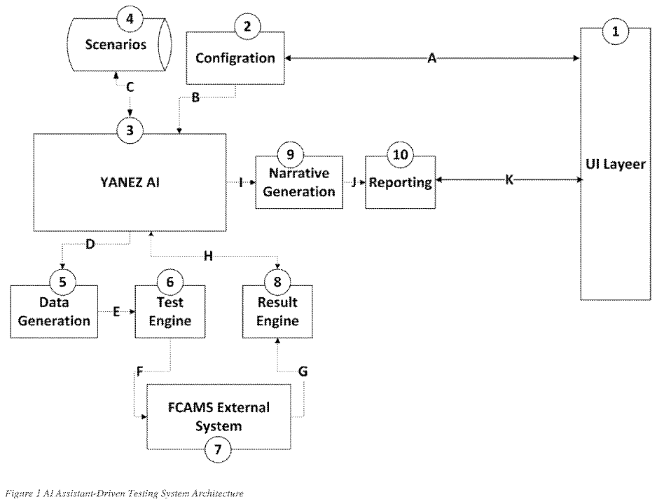

As depicted in FIG. 1 AI Assistant-Driven Testing System Architecture, the process begins with the UI Layer (1), where users interact with the system to input configurations. These configurations, which define the parameters and scenarios to be tested, are fed into the Configuration Module (2) via a bidirectional arrow labeled A. This module allows users to set up and tailor the system according to their specific requirements.

The Configuration Module (2) is connected to the core of the system YANEZ AI (3) through a unidirectional arrow labeled C, which sends the configuration data necessary to define various financial crime tests based on real-world threats. These configuration data are used by YANEZ AI (3) to define scenarios that are then used to generate synthetic inputs that simulate complex financial activities, such as money laundering, fraud, or sanctions violations. At the core of the system is YANEZ AI (3), which processes the inputs from both the Configuration Module (2) and Scenarios Module (4), as indicated by arrows B and C. YANEZ AI then generates synthetic data, conducts testing, and produces results.

Once the scenarios are defined, the Data Generation Module (5), responsible for creating synthetic data based on the scenarios and configurations provided, comes into play. This module utilizes advanced AI techniques, including generative models, to create synthetic data that mirrors the characteristics of real financial transactions. The generated data includes a wide range of transaction types, from standard transfers to those designed to mimic suspicious activity. The Data Generation Module (5) receives commands from YANEZ AI (3) through arrow D and sends the generated data to the Test Engine (6) via arrow E. Here, the synthetic data is tested against the target FCAMS under evaluation. The Test Engine (6) communicates with the FCAMS External System (7) via arrow F, allowing the system to assess how effectively the FCAMS can detect and respond to potential threats.

The outputs from the FCAMS are captured by the Result Engine (8), which processes these results to determine the accuracy and efficacy of the system being tested. The Result Engine (8) sends the processed results back to YANEZ AI (3) through arrow H for further analysis. It evaluates key metrics such as the rate of false positives (legitimate transactions flagged as suspicious) and false negatives (suspicious transactions not flagged), as well as how well the FCAMS complies with relevant regulatory requirements. These results are then synthesized into a comprehensive report.

In the next stage, the Narrative Generation Module (9) leverages natural language processing (NLP) to create a detailed narrative that explains the findings of the test. This narrative is designed to be easily understandable, even for users who may not have deep technical expertise. It includes insights into the strengths and weaknesses of the FCAMS, specific areas where the system performed well, and aspects that require improvement. The Narrative Generation Module (9) receives inputs from YANEZ AI (3) via arrow I.

This narrative is accompanied by visual representations, such as graphs and charts, to illustrate the data clearly. Finally, the Reporting Module (10) compiles the narrative, along with the detailed results and any recommended actions, into a final report. This report is delivered back to the user through the UI Layer (1) via arrow K, providing actionable insights that can be used to fine-tune the FCAMS, ensuring that it remains effective against evolving financial crime threats. Throughout this process, the YANEZ system's Feedback Loop allows it to continuously learn and adapt based on the outcomes of previous tests, making it a powerful tool for maintaining the integrity and compliance of financial institutions in an increasingly complex regulatory environment.

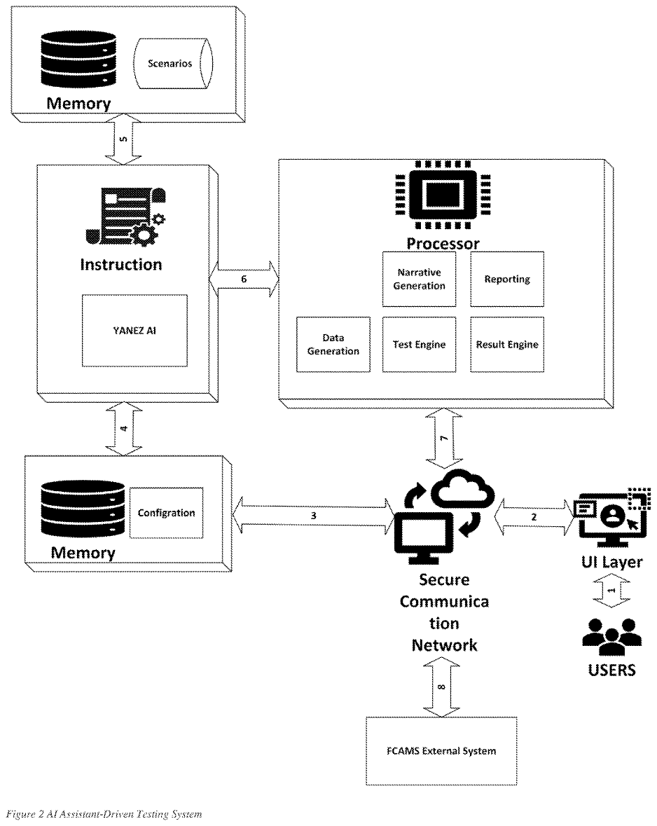

Continuing from the embodiment of the YANEZ system for testing Financial Crime Assessment and Monitoring Systems (FCAMS), the system is structured as illustrated in FIG. 2 AI Assistant-Driven Testing System, showing key system components connected by labeled arrows that indicate the data flow between them.

The UI Layer (2) allows users to input configurations and interact with the system, which is connected via a bidirectional arrow 2 to the Secure Communication Network. This network forms the central communication hub of the YANEZ system, ensuring secure transmission between various modules and users.

The Secure Communication Network is also linked to the Configuration Memory (3) via a unidirectional arrow 3, retrieving configuration data required for processing. Similarly, the Scenarios Memory (5) feeds predefined financial crime scenarios into the Instruction Module via a unidirectional arrow 5, which is crucial for generating the appropriate synthetic inputs.

At the system's core is the Instruction Module, where the YANEZ AI engine resides. This module processes inputs from the Scenarios Memory (5) and the Configuration Memory (4), directing synthetic data generation and testing. The Instruction Module is connected to the Processor via a bidirectional arrow 6, which handles the system's core computational tasks, such as synthetic data generation, test execution, and analysis.

The Processor manages several sub-modules:
Data Generation: Generates synthetic data based on the scenarios and configurations.
Test Engine: Executes tests by feeding the synthetic data into FCAMS.
Result Engine: Collects and processes the results from FCAMS, identifying false positives and false negatives.
Narrative generation and reporting: uses natural language processing (NLP) to produce reports detailing the system's performance and areas for improvement.

A critical connection in the system is the bidirectional arrow 7, which links the Processor to the Secure Communication Network, ensuring real-time data flow and feedback between these two components. This arrow enables continuous communication for data handling, feedback on synthetic test results, and report generation.

Additionally, the bidirectional arrow 8 connects the Secure Communication Network with the FCAMS External System, facilitating secure communication between the YANEZ system and the external FCAMS. This bidirectional flow ensures that the YANEZ system can send synthetic inputs to the FCAMS for testing and receive real-time results for evaluation.

Finally, through these interconnected pathways, the system ensures robust interaction between users, internal modules, and external FCAMS. The system facilitates the secure, efficient testing of financial crime scenarios, providing actionable insights and compliance reporting via the UI Layer (2).

YANEZ system operates in a distributed architecture where the core functionality of the system is separated into a primary and a secondary system to enhance scalability, redundancy, and specialized processing. In this embodiment, the Secondary System handles specific aspects of the

synthetic input generation and data analysis, working in parallel with the Primary System to optimize performance and accuracy in evaluating Financial Crime Assessment and Monitoring Systems (FCAMS).

The process begins similarly with the UI Layer (1), where users interact with both the primary and secondary systems to input configurations. These configurations, defining the parameters and scenarios to be tested, are simultaneously fed into the Configuration Module (2) of the primary system and a corresponding configuration interface in the secondary system. This dual configuration setup ensures that the secondary system can operate independently if necessary, providing a backup or handling specialized tasks such as processing high-risk transaction scenarios or specific regulatory compliance tests.

In the secondary system, the Scenario Definition Engine plays a crucial role in defining complex or less common financial crime scenarios that may not be the focus of the primary system. These scenarios are generated using specialized algorithms tailored to emerging threats or jurisdiction-specific regulations. The synthetic inputs generated by the secondary system's Data Generation Module (5) are then fed into a separate Test Engine (6), which may be dedicated to testing under high-load conditions or running simulations that require more computational resources than the primary system's engine.

The outputs from the secondary system's test engine are processed by its own Result Engine (8), which operates in sync with the primary system to provide a more comprehensive analysis. This result engine focuses on cross-validating the outputs with the primary system, ensuring consistency and identifying any discrepancies. It also handles specific metrics related to the scenarios it processes, such as those that might involve cross-border transactions or newer financial products.

Finally, the Narrative Generation Module (9) in the secondary system creates detailed narratives that are either integrated with or compared against those produced by the primary system. The reports generated by the secondary system's Reporting Module (10) can be merged with the primary reports or kept separate, depending on the user's needs. This modular and distributed architecture not only enhances the reliability and scalability of the YANEZ system but also allows for specialized processing and redundancy, ensuring that financial institutions can maintain high standards of compliance and effectiveness in detecting and mitigating financial crimes across diverse scenarios and jurisdictions.

In one embodiment, the YANEZ Synthetic Input Generation module operates as a critical component within the YANEZ AI system, designed specifically to create realistic and diverse financial transaction data for testing Financial Crime Assessment and Monitoring Systems (FCAMS). This module begins its process by receiving configuration inputs that define the parameters of the financial crime scenarios to be simulated. These parameters may include specific types of financial crimes, such as money laundering or fraud, the geographic region, the regulatory environment, and the characteristics of the entities involved. By tailoring these inputs, the system ensures that the generated data closely mirrors the actual conditions under which the FCAMS will operate, making the tests highly relevant and effective.

Once the configuration is established, the Synthetic Input Generation module employs advanced AI techniques, such as generative adversarial networks (GANs) and deep learning models, to create synthetic datasets that replicate real-world financial transactions. These datasets are designed to include a wide range of transaction types, from everyday banking activities to complex, high-risk transactions that are typically associated with financial crimes. The synthetic data is generated in a way that maintains the statistical properties and patterns found in real transaction data, ensuring that the FCAMS under test cannot easily distinguish between synthetic and actual data.

The generated synthetic data is then subjected to a series of checks within the YANEZ AI system to ensure its validity and relevance. This involves cross-referencing the synthetic transactions with known patterns of legitimate and illegitimate activity, as well as ensuring that the data adheres to the regulatory standards applicable to the region or industry being tested. This step is crucial for validating the robustness of the synthetic data and for ensuring that it provides a meaningful challenge to the FCAMS during testing.

After validation, the synthetic data is fed into the Test Engine, where it is processed in the same manner as real transaction data would be by the FCAMS. The Test Engine monitors how the FCAMS handles the synthetic inputs, paying particular attention to its ability to detect and respond to the simulated financial crimes. This process allows the YANEZ AI system to assess the effectiveness of the FCAMS in a controlled environment, providing detailed insights into its performance across various scenarios.

Finally, the results of the synthetic data tests are compiled and analyzed by the YANEZ AI system. Insights gleaned from these tests, such as the accuracy of the FCAMS in identifying suspicious transactions, are used to refine the synthetic data generation process. The YANEZ system's feedback loop ensures that with each test iteration, the synthetic input generation becomes more sophisticated, continuously improving its ability to simulate real-world financial crime scenarios and challenging the FCAMS to adapt and evolve in response to new threats. This iterative process ensures that the YANEZ AI system remains at the forefront of financial crime prevention technology.

The YANEZ Synthetic Input Generation module is designed to create synthetic entities, including names and corresponding demographic data, to test Financial Crime Assessment and Monitoring Systems (FCAMS). This embodiment specifically focuses on generating synthetic profiles of individuals, which are essential for evaluating how well FCAMS detect and assess risks associated with sanctioned or high-risk entities.

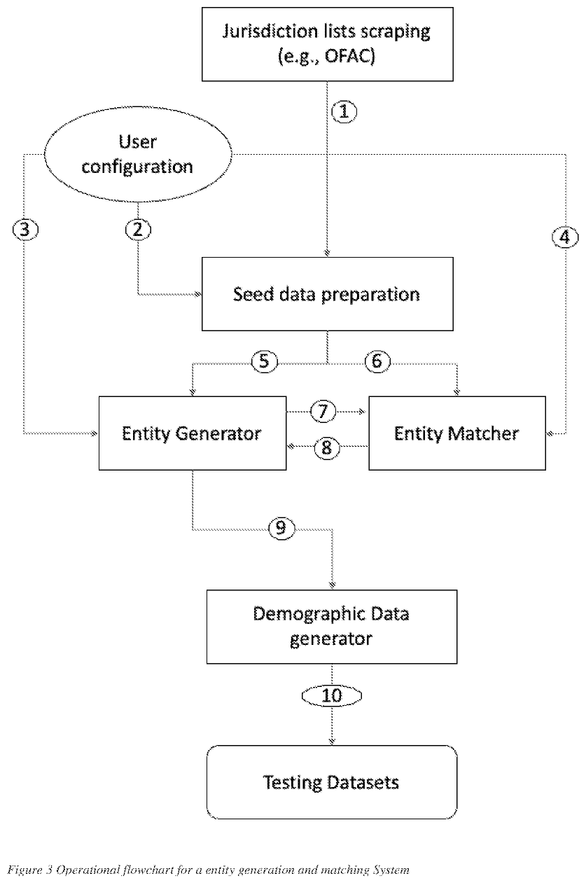

FIG. 3 Operational flowchart for a entity generation and matching System illustrates the process that begins with the Jurisdiction List Scraping to Seed Data Preparation (Step 1), where data from various jurisdiction lists, such as those provided by The Office of Foreign Assets Control (“OFAC”), is scraped and cleaned to form a seed dataset. This seed data serves as the foundation for generating realistic individual entities and profiles. The system allows for significant user configuration at this stage, where users can tailor the parameters for the data selection process to meet specific requirements. This configuration is crucial for ensuring that the synthetic profiles accurately reflect the types of entities that FCAMS need to monitor.

Next, the Entity Generator (Step 5) utilizes the prepared seed data to create new, synthetic Entity. These Entities are generated based on the parameters set during the user configuration phase. The system ensures that the names mirror real-world individual naming conventions and patterns, making them indistinguishable from actual names used in financial systems. In addition to generating entities'names, the system also includes a Demographic Data Generator (Step 9), which enriches each name with demographic information such as nationality, birth date, and other relevant details. This step is essential for creating comprehensive profiles that FCAMS can test against.

The generated entities and profiles are then evaluated by the Entity Matcher (Step 6), which assesses how closely the synthetic names match the entities in the seed data. This matching process involves a feedback loop (Step 8) where the results from the Entity Matcher are fed back into the Entity Generator. This iterative process ensures that the name generation becomes increasingly accurate and aligned with the desired outcomes, allowing the system to refine its synthetic profile generation continually.

Once the synthetic profiles are generated and validated, they are used to create Testing Datasets (Step 10). These datasets are employed to rigorously test the performance of FCAMS, evaluating how effectively these systems can detect and analyze the synthetic entities. The testing datasets are crafted to present a range of challenges to FCAMS, ensuring that they can handle a variety of scenarios, including detecting high-risk or sanctioned individuals based on the generated profiles.

The YANEZ Synthetic Input Generation module enhances the system's capability to create realistic, diverse profiles of individuals for testing FCAMS. By integrating a name generation system with demographic data enrichment and a robust feedback loop, the YANEZ system ensures that the synthetic profiles it produces are not only realistic but also relevant to the evolving challenges of financial crime monitoring.

In one embodiment, the YANEZ Assessment and Reporting Module plays a crucial role in evaluating the performance of Financial Crime Assessment and Monitoring Systems (FCAMS) after synthetic inputs have been generated and processed. The Assessment Module is responsible for directing these synthetic inputs into the targeted FCAMS, simulating real-world financial crime scenarios. As the FCAMS processes these inputs, the system captures and collects the outputs, which include data on detected suspicious activities, false positives, and false negatives. This data forms the foundation for the subsequent analysis performed by the Reporting Module. The Reporting Module is designed to meticulously analyze the outputs from the FCAMS against a set of predefined expected outcomes. This comparison is critical for determining the effectiveness of the FCAMS in identifying and managing financial crimes. The Reporting Module first generates a Test Score, a quantitative metric that reflects how well the FCAMS performed in detecting potential risks. This score is based on various factors, such as the accuracy of detection, the rate of false positives, and compliance with regulatory standards. The Test Score provides a clear, objective measure of the system's effectiveness, which is essential for evaluating its readiness for deployment in real-world scenarios.

Beyond the numerical Test Score, the Reporting Module also produces Insights, which are natural language explanations that interpret the test data. These insights offer a deeper understanding of the FCAMS′ performance by highlighting specific strengths and weaknesses observed during the testing process. For example, the insights might reveal patterns in how the FCAMS handles different types of transactions or identify areas where the system consistently underperforms. These insights are crucial for decision-makers who need to understand the nuances of the system's behavior and make informed decisions about its configuration and use. Based on the insights, the Reporting Module provides Suggested Actions that recommend specific steps to enhance the FCAMS′ performance. These recommendations might include adjusting configuration settings, improving data quality, or conducting further tests on certain scenarios. The Suggested Actions are tailored to address the particular issues identified during the assessment, providing a clear path forward for optimizing the system. This actionable feedback is a key component of the YANEZ system, ensuring that the FCAMS can evolve and improve over time.

Finally, the Reporting Module compiles all the relevant data into comprehensive reports, which include detailed Metrics, Analytics, and Results. Metrics offer quantifiable measures related to the test results, such as detection rates and compliance scores, while Analytics provide visual representations of the data, helping users to quickly grasp the testing outcomes. The Results section includes raw data from the testing activity, allowing for granular evaluation and further analysis if needed. These reports are exportable, making it easy for stakeholders to review the findings, share them with relevant parties, and take action based on the comprehensive analysis provided by the YANEZ system. This robust reporting capability ensures that financial institutions have the insights they need to maintain the effectiveness and compliance of their FCAMS.

The YANEZ Assessment and Reporting Module is designed to align with the Office of the Comptroller of the Currency (OCC) sampling guidelines, ensuring that the evaluation of Financial Crime Assessment and Monitoring Systems (FCAMS) is conducted with a high degree of statistical rigor. The Assessment Module directs synthetic inputs generated by the system into the FCAMS under review, simulating real-world financial crime scenarios. The FCAMS processes these inputs, and the system meticulously captures and collects the resulting outputs, which include data on detected suspicious activities, false positives, and false negatives. This data is then subjected to a comprehensive analysis guided by the OCC's statistical sampling methodologies.

To maintain compliance with the OCC's guidelines, the Reporting Module first defines the population of outputs from the FCAMS that will be analyzed. This step is critical in ensuring that the sample of outputs is representative of the broader population. The Reporting Module then applies a statistical sampling method, selecting outputs randomly from the defined population. This approach allows the YANEZ system to draw inferences about the entire population of FCAMS outputs based on the sample, providing a statistically valid assessment of the system's performance.

Once the sample is selected, the Reporting Module evaluates the FCAMS′ effectiveness by comparing the outputs against predefined expected outcomes. This evaluation includes calculating a Test Score, which serves as a quantitative metric reflecting the accuracy and reliability of the FCAMS. The Test Score is derived from key factors such as the rate of false positives, the rate of false negatives, and the system's compliance with relevant regulatory standards. This rigorous approach, in line with OCC guidelines, ensures that the Test Score provides a reliable measure of the FCAMS′ performance.

Beyond the Test Score, the Reporting Module also generates Insights, which are natural language explanations that interpret the test data and highlight specific areas where the FCAMS performed well or where improvements are needed. These insights are supported by detailed Metrics, Analytics, and Results, which offer quantifiable measures and visual representations of the testing outcomes. The use of OCC's statistical sampling methods ensures that these insights and metrics are not only accurate but also statistically valid, providing stakeholders with a high level of confidence in the findings.

Finally, the Reporting Module compiles the insights, metrics, and raw test data into comprehensive reports. These reports are designed to be exportable, allowing stakeholders to review the findings, share them with relevant parties, and take informed action based on the analysis. The integration of OCC sampling guidelines into the YANEZ system's Assessment and Reporting Module ensures that the evaluation of FCAMS is conducted with the highest standards of statistical rigor, providing financial institutions with the tools they need to maintain compliance and effectiveness in an increasingly complex regulatory environment.

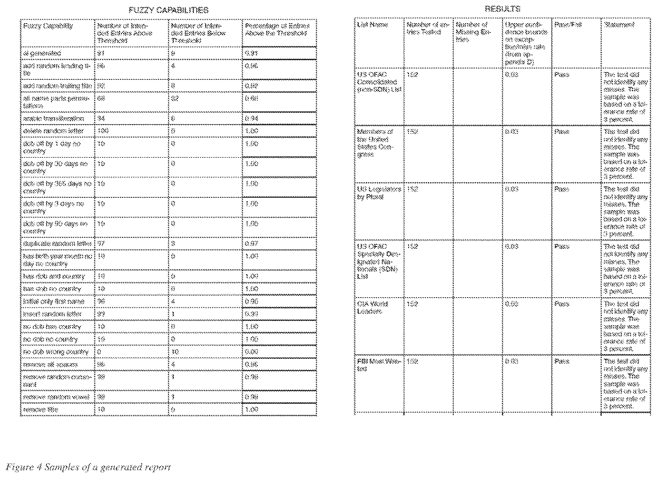

The YANEZ Assessment and Reporting Module is designed to align closely with the Office of the Comptroller of the Currency (OCC) sampling guidelines, ensuring that the evaluation of Financial Crime Assessment and Monitoring Systems (FCAMS) is conducted with a high degree of statistical rigor. As shown in FIG. 4 Samples of a generated report, the module is built to produce detailed reports that offer comprehensive insights into system performance across various jurisdictions and sanction lists. The Assessment Module directs synthetic inputs generated by the system into the FCAMS under review, simulating real-world financial crime scenarios with high fidelity. The FCAMS processes these inputs, and the YANEZ system captures and meticulously collects the resulting outputs, which include data on detected suspicious activities, false positives, and false negatives. This data forms the basis of a comprehensive analysis, guided by the OCC's statistical sampling methodologies, to ensure that the evaluation process is both thorough and compliant with regulatory standards.

To maintain compliance with the OCC's guidelines, the Reporting Module first defines the population of outputs from the FCAMS that will be analyzed, a crucial step in ensuring that the sample of outputs is representative of the broader population. The Reporting Module then applies a statistical sampling method, as prescribed by the OCC, selecting outputs randomly from the defined population. This approach allows the YANEZ system to draw valid inferences about the entire population of FCAMS outputs based on the sample, providing a statistically robust assessment of the system's performance.

Once the sample is selected, the Reporting Module evaluates the FCAMS′ effectiveness by comparing the outputs against predefined expected outcomes. This evaluation includes calculating a Test Score, a quantitative metric that reflects the accuracy, reliability, and overall effectiveness of the FCAMS. The Test Score is derived from key factors such as the rate of false positives, the rate of false negatives, and the system's compliance with relevant regulatory standards. This rigorous approach, in line with OCC guidelines, ensures that the Test Score provides a reliable measure of the FCAMS′ performance, which is essential for evaluating its readiness for deployment in real-world scenarios.

Beyond the Test Score, the Reporting Module generates Insights, which are natural language explanations that interpret the test data and highlight specific areas where the FCAMS performed well or where improvements are needed. These insights are further supported by detailed Metrics, Analytics, and Results, which offer quantifiable measures and visual representations of the testing outcomes. By adhering to the OCC's statistical sampling methods, these insights and metrics are not only accurate but also statistically valid, providing stakeholders with a high level of confidence in the findings. This is particularly important when making decisions about the system's configuration and potential areas for improvement.

Finally, the Reporting Module compiles all the relevant data into comprehensive reports, as illustrated in FIG. 4 Samples of a generated report. These reports include Testing Result Summaries, Fuzzy Capabilities assessments, Sanctions Results Per Jurisdiction, and Detailed Results and Comments, ensuring a thorough analysis. The reports are designed to be exportable, allowing stakeholders to review the findings, share them with relevant parties, and take informed action based on the analysis. The integration of OCC sampling guidelines into the YANEZ system's Assessment and Reporting Module ensures that the evaluation of FCAMS is conducted with the highest standards of statistical rigor, providing financial institutions with the tools they need to maintain compliance and effectiveness in an increasingly complex regulatory environment.

In one embodiment, the YANEZ Continuous Learning and Feedback Integration Module operates as a core component of the YANEZ AI Sanction Assistant, ensuring that the system remains adaptive and effective in the ever-evolving landscape of financial crime. This module is designed to continuously learn from various inputs, including user feedback, test results, and new data sources. As the system processes these inputs, it refines its synthetic input generation and assessment mechanisms, ensuring that the YANEZ AI remains at the cutting edge of financial crime prevention.

The learning process begins when the YANEZ system receives feedback from users, typically after the completion of a test cycle. This feedback might include insights into the system's performance, suggestions for improvement, or observations about how well the system's outputs align with the user's expectations. The YANEZ system analyzes this feedback to identify patterns or recurring issues, which are then used to adjust the algorithms that govern synthetic input generation and scenario configuration. This iterative process allows the system to evolve based on real-world user experience, improving its accuracy and relevance over time.

In addition to user feedback, the YANEZ Continuous Learning Module also incorporates data from the results of previous tests. Each time the system runs a test, it compares the FCAMS's performance against predefined benchmarks and expected outcomes. The differences between actual and expected results are analyzed, and the system learns from these discrepancies. For example, if the FCAMS consistently fails to detect certain types of transactions, the YANEZ system will adjust its synthetic input generation process to include more of these challenging scenarios in future tests. This ensures that the FCAMS is continuously challenged and can adapt to new threats.

Moreover, the YANEZ system is designed to ingest new data from external sources, such as updated regulatory guidelines, emerging financial crime trends, or new datasets that reflect changes in global financial activities. As this new data is integrated into the system, the Continuous Learning Module updates the models and scenarios used for synthetic input generation. This ensures that the YANEZ system remains aligned with the latest developments in the financial industry and regulatory landscape, maintaining its relevance and effectiveness. The Feedback Integration Process within YANEZ is not just a one-way street; it is a dynamic and ongoing cycle that enhances the system's capabilities with each iteration. As the system learns and adapts, it becomes more proficient at generating realistic synthetic inputs, assessing FCAMS performance, and providing actionable insights. This continuous improvement cycle ensures that the YANEZ AI Sanction Assistant remains a robust, adaptable tool, capable of meeting the challenges posed by evolving financial crime tactics and stringent regulatory requirements.

In one embodiment, the YANEZ AI system for testing and tuning Financial Crime Assessment and Monitoring Systems (FCAMS) incorporates advanced backtesting and sensitivity analysis methodologies. Backtesting and sensitivity analysis are widely used techniques in model validation and tuning processes, particularly within financial systems and risk management frameworks. Backtesting involves using historical data to evaluate how a model or system would have performed in the past under known conditions. This method is commonly used to assess the viability of transaction monitoring rules, sanction screening models, or overall financial crime assessment systems. By comparing the outcomes of a model's predictions with actual historical results, institutions can identify strengths and weaknesses in the system's detection capabilities. While historical performance provides insight, it's important to recognize that past conditions may not always reflect future market or criminal activities.

Sensitivity analysis, on the other hand, is a method used to assess how changes in input variables affect a model's outcomes. It is crucial in determining how different financial crime monitoring thresholds, such as Above the Line (ATL) and Below the Line (BTL) parameters, impact the system's accuracy. For example, adjusting input values like risk factor thresholds or transaction volume criteria can dramatically alter the detection rate for suspicious activities. Sensitivity analysis enables financial institutions to fine-tune their Financial Crime Assessment and Monitoring Systems (FCAMS) by identifying which parameters are most sensitive and should be prioritized in system tuning and rule adjustments.

In this embodiment, YANEZ AI employs both backtesting and sensitivity analysis to enhance the performance of FCAMS through model validation and rule tuning. YANEZ AI's synthetic input generator creates scenarios that simulate financial crimes such as money laundering and sanction violations, which are fed into the FCAMS. Through backtesting, the system evaluates whether the FCAMS would have correctly identified suspicious entities or transactions in historical contexts. This ensures that the FCAMS is effectively configured to handle real-world scenarios, helping financial institutions understand how well their systems would have performed in past compliance scenarios and how to refine them moving forward. Simultaneously, sensitivity analysis is employed to test how varying rule thresholds affect FCAMS performance, particularly in detecting financial crimes. By adjusting Above the Line (ATL) and Below the Line (BTL) monitoring rules—such as transaction size limits or pattern recognition algorithms—YANEZ AI helps institutions optimize detection efficiency while minimizing false positives and negatives. The system assesses the impact of each rule change, offering detailed insights into which parameters significantly affect system performance and which can be adjusted without compromising compliance standards.

In addition to model validation and rule tuning, YANEZ AI generates comprehensive reports based on both backtesting and sensitivity analysis results. These reports provide decision-makers with detailed insights, such as detection rates, false-positive rates, and missed suspicious activities. The feedback from these reports can be used to continuously refine FCAMS configurations, ensuring that the system is always prepared to address evolving financial crime threats. Through this iterative process, YANEZ AI enables continuous improvement of transaction monitoring and sanction screening systems, ultimately enhancing financial crime detection and regulatory compliance.

By integrating both backtesting and sensitivity analysis, YANEZ AI offers a holistic approach to model validation, allowing financial institutions to fine-tune their compliance systems with precision. This ensures that FCAMS can not only perform optimally in detecting suspicious activities but also adapt to changing regulatory environments and financial crime typologies. Through these validation techniques, YANEZ AI provides institutions with a future-proof, adaptive solution for managing the complexities of financial crime detection and prevention. In one embodiment, the YANEZ Data Handling and Compliance Module is designed to manage and secure the processing of multi-format data from various sources, ensuring that all activities within the YANEZ AI Sanction Assistant adhere to stringent regulatory standards. This module begins with the Data Ingestion Process, where data from a wide range of inputs—including transactional records, regulatory databases, and external risk assessments—is collected and formatted for use within the system. The data handling module is equipped to manage various data types, including structured, unstructured, and semi-structured data, ensuring that no critical information is overlooked during the analysis.

Once the data is ingested, it undergoes a Data Validation and Cleansing Process. This process ensures that all data entering the system is accurate, consistent, and free of errors or redundancies. The module uses advanced algorithms to detect and correct inconsistencies, such as duplicate entries or incomplete records. This step is crucial for maintaining the integrity of the synthetic inputs generated by the system, as any inaccuracies in the data could compromise the effectiveness of the FCAMS testing process. By ensuring that the data is clean and reliable, the YANEZ system can generate more accurate and meaningful synthetic inputs.

The system also incorporates a Compliance Verification Module, which plays a critical role in ensuring that all synthetic inputs and generated reports comply with relevant regulatory standards. This module is configured to check the data and testing processes against a wide array of jurisdictional requirements, including those from financial regulators such as The Office of Foreign Assets Control (“OFAC”), Financial Crimes Enforcement Network (“FinCEN”), and the European Union's AML directives. The Compliance Verification Module continuously updates its regulatory database to reflect the latest changes in laws and guidelines, ensuring that the YANEZ system remains compliant with evolving standards.

In addition to regulatory compliance, the YANEZ Data Handling and Compliance Module is designed with robust Data Security Protocols. These protocols include encryption, access control, and secure storage measures that protect sensitive financial data from unauthorized access or breaches. The system employs end-to-end encryption during data transmission and storage, ensuring that data remains secure throughout its lifecycle. Access to the data is strictly controlled and monitored, with audit trails that track any changes or access to sensitive information.

Finally, the YANEZ system's Data Reporting Functionality ensures that all reports generated from the testing process are fully compliant and can be easily audited by regulatory bodies. The reports are designed to include all necessary documentation, such as the source of the data, the methodologies used in testing, and the results of the compliance checks. This transparency not only ensures that the YANEZ system's outputs are trustworthy but also provides financial institutions with the documentation they need to demonstrate compliance with regulatory standards. By integrating these robust data handling and compliance features, the YANEZ AI Sanction Assistant ensures that financial institutions can effectively test and monitor their FCAMS while adhering to the highest standards of data security and regulatory compliance.

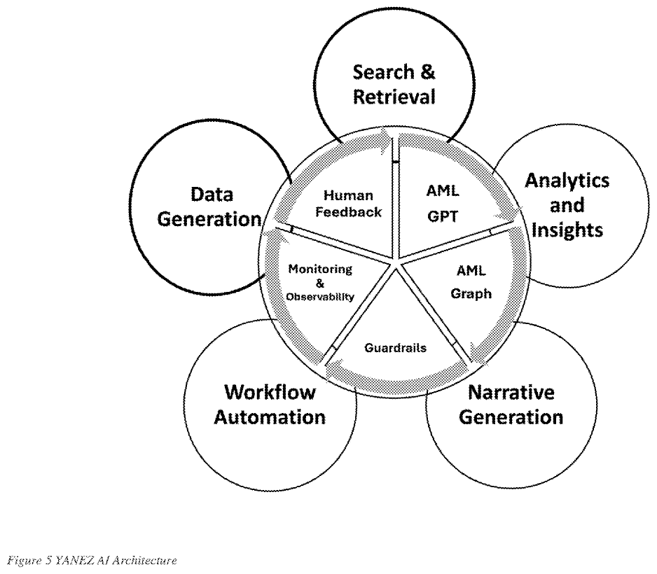

As described in FIG. 5 YANEZ AI Architecture, YANEZ AI is engineered to operate within environments where high accuracy, reliability, and compliance with legal and ethical standards are paramount. Specifically designed for compliance and sanctions analysis, the system is built upon a multi-layered AI core architecture that integrates advanced technologies and tools to deliver real-time insights, ensure ethical decision-making, and facilitate operational efficiency. The architecture is composed of several components, as described below:

### AI Core Components:

1. AML GPT: At the heart of YANEZ AI's analytical capabilities is AML GPT, a language model that has been fine-tuned specifically for Anti-Money Laundering (AML) tasks. This model is designed to handle complex queries, extract insights from large data sets, and generate contextually accurate reports related to compliance and sanctions. By leveraging this tailored language model, the system can interpret nuanced regulatory language and respond to specific AML-related inquiries, offering precise and actionable insights.
2. AML Graph: The system integrates an AML Graph, a dynamic knowledge graph that captures, stores, and analyzes relationships between entities relevant to AML processes. This graph continuously updates as new data is ingested, providing a robust and interconnected view of transactions, entities, and their relationships, helping to reveal potential risks such as hidden ownership structures, beneficial owners, or networks of politically exposed persons (PEPs). The graph enables a deeper understanding of how various entities are linked in financial crime schemes, supporting more accurate risk assessments.
3. Guardrails: To ensure that the AI operates within legal and ethical boundaries, YANEZ AI includes built-in Guardrails. These are ethical guidelines and validation mechanisms that review AI outputs, ensuring compliance with local and international regulations. The guardrails prevent the AI from providing outputs that could be misaligned with regulatory frameworks or ethical considerations, ensuring that all generated insights are reliable and legally sound.
4. Monitoring and Observability: The system also integrates Monitoring and Observability tools that track and report on the system's performance, accuracy, and reliability. These tools are essential for ensuring continuous improvement of the AI system. They allow for real-time performance assessments, alerting operators to potential issues with data quality or model drift. These observability features ensure the system can be continuously optimized to meet evolving regulatory and business requirements.

### Specialized AI Agents:

The YANEZ AI system operates through a series of specialized AI agents designed to handle specific tasks, maximizing efficiency and accuracy across various workflows:
1. Search & Retrieval: This agent is responsible for quickly and accurately collecting relevant data from internal and external sources. It streamlines the process of gathering compliance data, reducing the time it takes for human operators to manually search for information. The Search & Retrieval agent ensures that relevant documents, news, and regulatory updates are processed and available for immediate analysis.
2. Narrative Generation: The Narrative Generation agent automatically creates detailed and reliable reports based on the AI's analysis. It uses natural language processing to convert data insights into clear, actionable reports. This functionality helps compliance teams by reducing the burden of manually drafting reports and ensuring consistency in the language used to explain findings.
3. Analytics and Insights: The Analytics and Insights agent provides real-time, data-driven insights that help compliance teams assess risk levels and trends across financial activities. It visualizes critical patterns, highlighting potential red flags and areas that require further investigation. By offering intuitive analytics, this agent supports better decision-making for both compliance officers and financial crime investigators.
4. Workflow Automation: Routine compliance tasks, such as screening, transaction monitoring, and report generation, are handled by the Workflow Automation agent. This reduces the manual effort required from compliance teams, allowing them to focus on more complex, high-risk areas. The agent integrates smoothly with existing workflows, ensuring that compliance processes are both scalable and efficient.
5. Data Generation: The Data Generation agent creates synthetic data for testing and validation purposes. This is particularly useful when evaluating the performance of Financial Crime Assessment and Monitoring Systems (FCAMS) under various scenarios, including sanctions screening and transaction monitoring. The synthetic data mimics real-world transactions and entities, enabling rigorous testing without exposing sensitive data.

Through this architecture, the YANEZ AI system offers financial institutions a powerful tool to stay compliant, detect and mitigate financial crime risks, and enhance operational efficiency. The combination of AI-driven components and specialized agents ensures that the system remains adaptive, reliable, and aligned with both regulatory and ethical standards.

In one example use case of the YANEZ system, the focus is on testing the accuracy and robustness of a Financial Crime Assessment and Monitoring System (FCAMS) in detecting sanctioned entities. Sanctioned entities refer to individuals, businesses, or organizations that are restricted or prohibited from engaging in financial activities due to regulatory measures, such as being listed on the OFAC Specially Designated Nationals and Blocked Persons (SDN) List.

### Testing Sanctioned Entities Detection With Synthetic Data

1. Generating Synthetic Entries: The YANEZ system is first configured to simulate a sanctioned entities scenario. To do this, it generates synthetic entries representing individuals, companies, or organizations that appear on well-known sanction lists like OFAC's SDN list. These synthetic entries are designed to mimic real-world sanctioned entities in terms of personal details, business affiliations, and other identifying information.
2. Feeding Data into FCAMS: Once the synthetic sanctioned entities are created, the YANEZ system injects these entries into the target FCAMS under evaluation. This is done to simulate real-time financial activity, where the sanctioned entities attempt to interact with financial institutions or services. The YANEZ system monitors how the FCAMS processes these entries.
3. Evaluating Detection Accuracy: The YANEZ system tracks whether the FCAMS successfully identifies and flags the synthetic sanctioned entities as high-risk or restricted from financial activities. During this evaluation, the system also captures any discrepancies, such as:
   False positives: Legitimate transactions or individuals that are incorrectly flagged as sanctioned.
   False negatives: Sanctioned entities that are missed or not flagged by the FCAMS.
4. Report Generation: After testing, the YANEZ system generates a detailed report. This report includes:
   Test Score: A numerical representation of the FCAMS′ effectiveness in identifying sanctioned entities. This score is based on detection rates, including false positives and negatives.
   Insights: Narrative explanations that provide a deeper understanding of the system's performance. These insights could identify patterns, such as whether the FCAMS struggles with certain types of entries (e.g., complex business networks or individuals with alias names).
   Suggested Actions: Recommendations on how the FCAMS can be fine-tuned to improve its accuracy, such as adjusting screening parameters or integrating more data sources.
5. Continuous Feedback Loop: The insights from the report allow the YANEZ system to refine its synthetic input generation process and continuously test and improve the FCAMS. Over time, the system adapts to changes in sanctioned entity typologies and regulatory requirements, ensuring that financial institutions remain compliant and effective in identifying and mitigating financial crime risks.

This Sanctioned Entities Scenario use case demonstrates how the YANEZ system can serve as a critical tool for financial institutions, allowing them to rigorously test their FCAMS for compliance with sanctioning regulations and maintain robust defenses against financial crime.

In another example use case, the YANEZ system tests the ability of a Financial Crime Assessment and Monitoring System (FCAMS) to detect suspicious transactions that may indicate money laundering or other financial crimes. This Transaction Monitoring Scenario focuses on evaluating the FCAMS′ capabilities when handling complex transaction patterns, including structuring and layering, two well-known techniques used in money laundering schemes.

Testing Transaction Monitoring with Synthetic Data
1. Creating Synthetic Financial Transactions: The YANEZ system is configured to generate synthetic financial transactions that mimic real-world money laundering activities. These synthetic transactions replicate techniques such as structuring (where large amounts of money are broken into smaller, less suspicious transactions) and layering (where illicit funds are moved through a series of complex financial transactions to obscure their origin). The system generates a variety of transaction types, including cash deposits, international wire transfers, and cryptocurrency exchanges.
2. Feeding Transactions into FCAMS: The synthetic transactions are then fed into the FCAMS being evaluated. The system simulates these transactions being processed in real-time, assessing the FCAMS′ ability to monitor and analyze them for suspicious activity. The goal is to determine how well the FCAMS can detect patterns indicative of money laundering, such as unusually frequent transactions or cross-border movements involving high-risk jurisdictions.
3. Evaluating Detection and Alerts: As the FCAMS processes the synthetic transactions, the YANEZ system tracks whether the FCAMS generates the appropriate alerts for suspicious activities. Key metrics evaluated include:
   Suspicious Transaction Reports (STRs): Whether the FCAMS correctly flags suspicious transactions for further investigation.
   False Positives: Legitimate transactions that are incorrectly flagged as suspicious.
   False Negatives: Suspicious transactions that are missed or not flagged by the FCAMS.
4. Report Generation: After the transaction monitoring tests are complete, the YANEZ system generates a comprehensive report that includes:
   Test Score: A quantitative evaluation of how effectively the FCAMS identified suspicious activities. This score reflects how accurately the system detected money laundering techniques, while also accounting for false positives and negatives.
   Insights: Narrative explanations that analyze the FCAMS′ strengths and weaknesses. For instance, the report might highlight areas where the system excels, such as detecting structured transactions, but also indicate challenges in identifying more complex layering techniques.
   Suggested Actions: Actionable recommendations to improve the FCAMS′ transaction monitoring capabilities. These could include suggestions for fine-tuning transaction monitoring thresholds, enhancing cross-border transaction analytics, or integrating additional data sources to improve accuracy.
5. Continuous Learning and Improvement: The YANEZ system's feedback loop ensures that the results of each test iteration are used to enhance the synthetic transaction generation process. By continuously refining its models, YANEZ helps financial institutions adapt to evolving money laundering techniques and regulatory requirements.

This Transaction Monitoring Scenario use case highlights the YANEZ system's ability to rigorously evaluate and improve the transaction monitoring capabilities of FCAMS. By simulating complex money laundering techniques, YANEZ provides institutions with valuable insights into how well their systems are equipped to detect and respond to suspicious financial activities.

In this example, the YANEZ system tests the ability of a Financial Crime Assessment and Monitoring System (FCAMS) to detect entities linked to adverse media coverage, such as negative reports from social media platforms or dark web sources. This scenario evaluates how effectively the FCAMS can respond to potential reputational risks or signals of criminal activity based on media coverage.

Testing Adverse Media Detection with Synthetic Entities
1. Generating Synthetic Entities with Adverse Media Links: The YANEZ system is configured to generate synthetic entities that are linked to negative media reports. These synthetic entities could represent individuals, organizations, or businesses flagged for involvement in illegal activities or unethical behavior. The sources of these media reports are modeled from social media platforms, news outlets, and dark web discussions that highlight adverse events or accusations. By simulating such scenarios, YANEZ provides a rich dataset for testing the FCAMS′ adverse media screening capabilities.
2. Feeding Data into FCAMS: Once the synthetic entities with adverse media links are created, the YANEZ system injects these entities into the FCAMS under review. The system monitors how the FCAMS processes these synthetic entities and whether it accurately identifies the negative media associations, which are typically flagged as potential risks for money laundering, fraud, or other criminal activities.
3. Evaluating Detection and Alerts: During the evaluation, the YANEZ system tracks whether the FCAMS successfully detects and raises alerts based on adverse media mentions. It evaluates the system's ability to:
   Detect entities flagged in negative social media reports.
   Respond to dark web discussions linked to criminal activities or suspicious behavior.
   Identify patterns that associate certain entities with risky or unethical activities.

The evaluation also includes detecting potential false positives (entities incorrectly flagged based on media coverage) and false negatives (missed entities associated with adverse media reports).
4. Report Generation: Following the test, the YANEZ system produces a detailed report that includes:
   Test Score: A quantitative metric representing how well the FCAMS identified entities linked to adverse media. This score considers detection accuracy, as well as the number of false positives and negatives.
   Insights: The report provides deeper insights into the performance of the FCAMS in identifying media-related risks. For example, it may reveal that the FCAMS was more successful in detecting social media mentions but struggled with dark web sources.
   Suggested Actions: Actionable recommendations are provided to improve the FCAMS′ adverse media screening capabilities. These actions might include adjusting the parameters for media source analysis, integrating additional social media or web scraping tools, or enhancing keyword detection for dark web mentions.
5. Continuous Improvement and Adaptation: The YANEZ system incorporates feedback from the test results to refine its synthetic entity generation process and continuously challenge the FCAMS with evolving media-related risk scenarios. By adapting to new trends in media coverage, the system ensures that the FCAMS remains effective in responding to both traditional news and emerging threats from social media and the dark web.

This Adverse Media Scenario use case showcases how the YANEZ system helps financial institutions assess their FCAMS′ ability to identify risks stemming from negative media reports. By simulating adverse media scenarios, YANEZ provides actionable insights and suggestions for optimizing media-related risk detection.

1. A method for testing financial crime assessment and monitoring systems (FCAMS), comprising:
A synthetic input generator powered by the YANEZ AI Sanction Assistant, configured to produce synthetic inputs based on a set of configurable target scenarios;
an assessment module configured to input said synthetic inputs into one or more FCAMS and receive results from the FCAMS;
a reporting module configured to analyze the received results and generate test scores, insights, suggested actions, metrics, analytics, and raw results;
a feedback module configured to receive and incorporate user feedback on the accuracy and usefulness of the test results;
an AI-driven engine within YANEZ AI that continuously learns from scenarios, configurations, results, analytics, insights, and feedback to refine the synthetic input generation and assessment processes;
a data ingestion module within YANEZ AI that aggregates and processes data from regulatory sources, commercial databases, and publicly available sources to ensure comprehensive and up-to-date synthetic inputs.

2. The method of claim 1, wherein the YANEZ AI Sanction Assistant is configured to generate synthetic inputs for specific target scenarios, further comprising to:
Sanctioned Entities, wherein synthetic entities represent individuals, businesses, or other entities subject to sanctions or classified as Politically Exposed Persons (PEPs);
Transaction Monitoring, wherein synthetic transactions are generated to mimic financial activities associated with money laundering or payment fraud;
Adverse Media, wherein synthetic entities are associated with adverse or negative media reports.

3. The method of claim 1, wherein the reporting module, driven by YANEZ AI, is further configured to generate exportable reports that compromise of one or more of the following: test scores, method, suggested actions, metrics, analytics, and raw results.

4. The method of claim 1, wherein the YANEZ AI Sanction Assistant includes a continuous learning module that refines its synthetic input generation based on historical test results, user feedback, and newly ingested data.

5. The method of claim 1, wherein the synthetic input generator is further configured to allow user customization of input parameters, enables the generation of synthetic data tailored to specific FCAMS configurations and use cases.

6. The method of claim 2, wherein the Sanctioned Entities scenario further includes synthetic input configurations for testing compliance with international sanctions lists, further comprising The Office of Foreign Assets Control (“OFAC”) Specially Designated Nationals and Blocked Persons list (“SDN List”), EU sanctions, and United Nation (“UN”) sanctions.

7. The method of claim 2, wherein the Transaction Monitoring scenario further compromises of the generation of synthetic transaction patterns that replicate various typologies, such as structuring, smurfing, round-tripping, and layering, commonly associated with money laundering schemes.

8. The method of claim 2, wherein the Adverse Media scenario further compromises of synthetic inputs designed to test FCAMS′ capabilities to detect emerging risks from non-traditional news sources, including social media and dark web forums.

9. The method of claim 1, wherein the reporting module further compromises of real-time analytics capabilities, allows users to visualize test results through interactive dashboards and drill-down features for detailed analysis.

10. The method of claim 1, wherein the feedback module compromises an automated feedback loop, where user inputs are automatically processed to update the AI models and improve the accuracy and relevance of future synthetic inputs and assessments.

11. The method of claim 1, wherein the data ingestion module of the YANEZ AI Sanction Assistant is configured to support multi-format data ingestion, allowing the system to process structured and unstructured data, including text, images, and other media types, to enrich the synthetic input generation process.

12. The method of claim 1, wherein the YANEZ AI Sanction Assistant includes a compliance verification module, ensuring that the synthetic inputs and generated reports meet all relevant regulatory requirements for the jurisdictions being tested.

13. The method of claim 1, wherein the synthetic input generator can be dynamically updated based on changes in regulatory requirements, emerging threats, or user-defined criteria, ensures the system remains up-to-date with the latest compliance and risk management standards.

14. The method of claim 1, wherein the YANEZ AI Sanction Assistant is configured to generate explanatory insights alongside synthetic inputs, providing context and rationale for the generated data, helping users to understand the scenarios being tested.

15. The method of claim 1, further comprises a secure data handling module within YANEZ AI, ensuring that all synthetic inputs, test results, and user feedback are stored and processed in a secure and compliant manner, protecting sensitive information.

16. The method of claim 1, wherein the AI-driven engine utilizes machine learning methodologies and natural language processing to enhance the generation and analysis of synthetic inputs and FCAMS outputs.

17. The method of claim 1, wherein the YANEZ AI Sanction Assistant is further configured to integrate with third-party APIs and data sources to continuously update and expand the synthetic input datasets.

18. The method of claim 1, wherein the reporting module provides customizable report templates, allows users to tailor the format and content of the generated reports to meet specific organizational or regulatory requirements.

19. The method of claim 1, wherein the AI-driven engine compromises anomaly detection capabilities to identify and flag unexpected patterns in FCAMS responses during the testing process.

20. A system for testing financial crime assessment and monitoring systems (FCAMS), comprising:
Synthetic Input Generator powered by the YANEZ AI Sanction Assistant, configured to produce synthetic inputs based on a set of configurable target scenarios;
Assessment Module configured to input said synthetic inputs into one or more FCAMS and receive results from the FCAMS;
Reporting Module configured to analyze the received results and generate test scores, insights, suggested actions, metrics, analytics, and raw results;
Feedback Module configured to receive and incorporate user feedback on the accuracy and usefulness of the test results;
AI-Driven Engine within YANEZ AI that continuously learns from scenarios, configurations, results, analytics, insights, and feedback to refine the synthetic input generation and assessment processes;
Data Ingestion Module within YANEZ AI that aggregates and processes data from regulatory sources, commercial databases, and publicly available sources to ensure comprehensive and up-to-date synthetic inputs;
UI Layer for user input configurations and system interaction, connected to the Secure Communication Network via a bidirectional communication interface, enabling secure data flow and feedback between system modules and users;
Configuration Memory and Scenarios Memory for storing predefined financial crime scenarios and configuration data, connected to the Instruction Module where the YANEZ AI engine processes inputs and directs synthetic data generation;
Processor linked to the Instruction Module via a bidirectional interface, responsible for handling core computational tasks, including synthetic data generation, test execution through the Test Engine, result processing via the Result Engine, and generating detailed reports via the Narrative Generation and Reporting Sub-modules;
Secure Communication Network facilitating real-time communication between internal modules, users, and external FCAMS, ensuring the secure transmission of synthetic inputs and the reception of real-time results for evaluation.
